(19) United States
(12) Patent Application Publication
(10) Pub. No.: US 2025/0234805 A1
(43) Pub. Date: Jul. 24, 2025

(54) FLEXIBLE HEADER FOR AN AGRICULTURAL HARVESTER

(71) Applicant: CNH Industrial America LLC, New Holland, PA (US)

(72) Inventor: Tyler Romoser, Keota, IA (US)

(21) Appl. No.: 19/032,532

(22) Filed: Jan. 21, 2025

Related U.S. Application Data
(60) Provisional application No. 63/623,490, filed on Jan. 22, 2024.

(51) Int. Cl. A01D 41/14

(52) U.S. Cl. CPC A01D 41/14

(57) ABSTRACT

A flexible header for an agricultural harvester includes a crop engagement assembly having a first portion and a second portion. The first portion is configured to couple to a first row unit of the flexible header, and the second portion is configured to couple to a second row unit of the flexible header, which is directly adjacent to the first row unit. Furthermore, the first and second portions are configured to move relative to one another in response to lateral flexing of the flexible header at a pivot joint positioned laterally between the first and second row units, and the crop engagement assembly is configured to establish an uninterrupted crop engaging exterior during the lateral flexing of the flexible header.

### BACKGROUND

The present disclosure relates generally to a flexible header for an agricultural harvester.

An agricultural harvester may be used to harvest agricultural crops, such as barley, beans, beets, carrots, corn, cotton, flax, oats, potatoes, rye, soybeans, wheat, or other plant crops. The agricultural harvester may include a header, which may be configured to efficiently harvest certain types of crops. For example, a corn header may be configured to efficiently harvest corn. The corn header may include row units that include components configured to separate ears of corn from stalks as the agricultural harvester travels through a field. Conveyors (e.g., augers) carry the ears of corn toward a processing system of the agricultural harvester, and the stalks are deposited on the field. Certain corn headers include a rigid frame configured to support the row units and the conveyors. Unfortunately, the rigid frame may not enable the row units to effectively follow the contours of the field.

### BRIEF DESCRIPTION

In certain embodiments, a flexible header for an agricultural harvester includes a crop engagement assembly having a first portion and a second portion. The first portion is configured to couple to a first row unit of the flexible header, and the second portion is configured to couple to a second row unit of the flexible header, which is directly adjacent to the first row unit. Furthermore, the first and second portions are configured to move relative to one another in response to lateral flexing of the flexible header at a pivot joint positioned laterally between the first and second row units, and the crop engagement assembly is configured to establish an uninterrupted crop engaging exterior during the lateral flexing of the flexible header.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a corn header;

FIG. 2 is a perspective view of an embodiment of a corn header that may be employed within the agricultural harvester of FIG. 1;

FIG. 3 is a perspective front view of a portion of the corn header of FIG. 2;

FIG. 4 is a schematic cross-sectional view of an embodiment of crop engagement assemblies that may be employed within the corn header of FIG. 2;

FIG. 5 is a schematic cross-sectional view of another embodiment of crop engagement assemblies that may be employed within the corn header of FIG. 2; and

FIG. 6 is a schematic cross-sectional view of a further embodiment of crop engagement assemblies that may be employed within the corn header of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related to constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

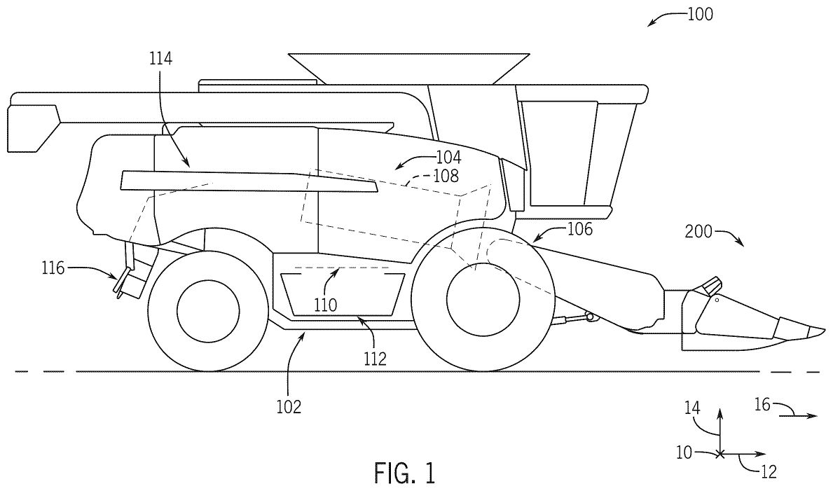

FIG. 1 is a side view of an embodiment of an agricultural harvester 100 having a corn header 200 (e.g., agricultural header). The agricultural harvester 100 includes a chassis 102 configured to support the corn header 200 and an agricultural crop processing system 104. As described in greater detail below, the corn header 200 is configured to separate ears of corn from stalks and to transport the ears of corn toward an inlet 106 of the agricultural crop processing system 104 for further processing of the ears of corn. The agricultural crop processing system 104 receives the ears of corn from the header 200 and separates desired crop material from crop residue. For example, the agricultural crop processing system 104 may include a thresher 108 having a cylindrical threshing rotor that transports the ears of corn in a helical flow path through the agricultural harvester 100. In addition to transporting the ears of corn, the thresher 108 may separate certain desired crop material (e.g., corn kernels) from the crop residue, such as husks and cobs, and enable the desired crop material to flow into a cleaning system 110 located beneath the thresher 108. The cleaning system 110 may remove debris from the desired crop material and transport the desired crop material to a storage compartment 112 within the agricultural harvester 100. The crop residue may be transported from the thresher 108 to a crop residue handling system 114, which may remove the crop residue from the agricultural harvester 100 via a crop residue spreading system 116 positioned at the aft end of the agricultural harvester 100.

As discussed in detail below, the header 200 includes multiple row units configured to separate ears of corn from stalks, thereby leaving bare stalks engaged with the soil. The ears of corn are directed toward the inlet 106. To facilitate discussion, the agricultural harvester 100 and/or its components (e.g., the corn header 200) may be described with reference to a lateral axis or direction 10, a longitudinal axis or direction 12, and a vertical axis or direction 14. The agricultural harvester 100 and/or its components (e.g., the corn header 200) may also be described with reference to a direction of travel 16.

As discussed in detail below, the corn header 200 is flexible, thereby forming a flexible header, which enables the row units to more effectively follow the contours of the field (e.g., as compared to a rigid header). For example, in certain embodiments, the corn header 200 includes a frame having a first section and a second section. The corn header 200 also includes a pivot joint that pivotally couples the first and second sections of the frame to one another. A first row unit of the corn header is positioned on a first lateral side of the pivot joint (e.g., first side with respect to the lateral axis 10 of the corn header 200), and a second row unit is positioned on a second lateral side of the pivot joint (e.g., second side with respect to the lateral axis 10 of the corn header 200), opposite the first lateral side. The first and second row units are directly adjacent to one another on the corn header 200. The corn header 200 also includes a crop engagement assembly (e.g., including a hood and/or a divider) having a first portion and a second portion. The first portion is coupled to the first row unit, and the second portion is coupled to the second row unit. In addition, the first and second portions are configured to move relative to one another in response to lateral flexing of the corn header at the pivot joint (e.g., rotation of the first and second sections of the frame relative to one another). The crop engagement assembly is configured to establish an uninterrupted crop engaging exterior during the lateral flexing of the corn header 200, thereby blocking crop material from passing through the crop engagement assembly. Accordingly, the crop engagement assembly enables the corn header 200 to laterally flex while effectively directing crop material into/through the first row unit.

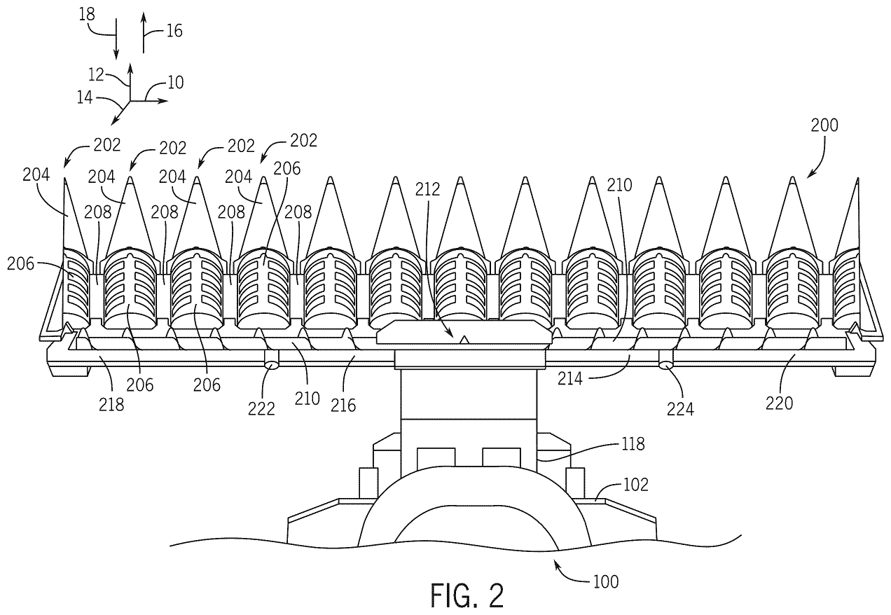

FIG. 2 is a perspective view of an embodiment of a corn header 200 that may be employed within the agricultural harvester 100 of FIG. 1. In the illustrated embodiment, the corn header 200 includes multiple crop engagement assemblies 202 distributed along the lateral axis 10 of the corn header 200. Each crop engagement assembly 202 includes a divider 204 and a hood 206. The dividers 204 are configured to divide rows of a crop (e.g., corn), and the hoods 206 are configured to block crop material from entering internal components of the corn header 200. The dividers 202 may be evenly spaced along the lateral axis 10 of the corn header 200. As the corn header 200 moves along the direction of travel 16, the dividers 204 direct crop material from each row into a respective row unit 208. In addition, the hoods 206 facilitate alignment of the crop material with the row units 208. Accordingly, the hoods 206 direct the crop material through the row units 208.

The row units 208 are configured to separate ears of corn from stalks, thereby leaving bare stalks engaged with the soil (e.g., stubble). The ears of corn may be directed to one of a pair of augers 210 configured to convey the ears of corn inwardly along the lateral axis 10 of the corn header 200 to a conveyor 212 at the lateral center of the corn header 200. As illustrated, the augers 210 extend along a substantial portion of the width of the corn header 200 (e.g., along the lateral axis 10 of the corn header 200). The augers 210 may be driven by a driving mechanism (e.g., electric motor, hydraulic motor, etc.). As the agricultural harvester 100 moves through the field, the dividers 204 direct the rows of crops/crop material into the row units 208. The row units 208 engage the crop material within the field and separate the ears of corn from the stalks, and the augers 210 transport the ears of corn to the conveyor 212, which directs the ears of corn toward the inlet of the agricultural crop processing system. Each row unit 208 includes feed rollers which pull the stalk of each crop downwardly through the row unit during harvesting. As the stalks of the crops are pulled through the feed rollers, the ears are separated from the stalks and are conveyed toward the augers 210.

In addition to pulling the stalks of the crops downwardly, the feed rollers drive the stalks rearwardly (e.g., along a rearward direction 18 opposite the direction of travel 16) relative to a frame 214 of the corn header 200. Due to the movement of the agricultural harvester 100, the frame 214 of the corn header 200 is driven to move forwardly along the direction of travel 16. The difference between the forward speed of the corn header frame 214 relative to the field and the rearward speed of the stalks relative to the corn header frame 214 may be referred to as the conveyance speed. A conveyance speed of about zero may enhance the efficiency of the harvesting operation (e.g., by reducing the loads/forces applied to the ears) and/or may enhance subsequent agricultural operation(s) (e.g., by enhancing the engagement of the bare stalks with the soil).

In the illustrated embodiment, the frame 214 of the corn header 200 includes a center section 216 (e.g., first section), a left wing section 218 (e.g., second section), and a right wing section 220 (e.g., third section). The sections are pivotally coupled to one another by respective pivot joints. As illustrated, a first pivot joint 222 pivotally couples the left wing section 218 to the center section 216, and a second pivot joint 224 pivotally couples the right wing section 220 to the center section 216. Each pivot joint is configured to enable the adjacent frame sections to pivot relative to one another (e.g., about a pivot axis parallel to the longitudinal axis 12 of the corn header 200). In certain embodiments, the center section 216 is rigidly coupled to a feed house 118 of the agricultural harvester 100. However, in other embodiments, the center section is pivotally coupled to the feeder house. The pivot joints enable the corn header 200 to laterally flex as the agricultural harvester 100 moves along the direction of travel 16, thereby enabling the row units 208 to more effectively follow the contours of the field (e.g., as compared to a rigid header). As used herein, “laterally flex” and “lateral flexing” refer to flexing of the corn header along the lateral axis of the corn header (e.g., about pivot axis/axes parallel to the longitudinal axis of the corn header). While the corn header 200 includes two pivot joints and three frame sections in the illustrated embodiment, in other embodiments, the corn header may include more or fewer pivot joints (e.g., 1, 3, 4, 5, 6, or more) and a corresponding number of frame sections.

In the illustrated embodiment, each pivot joint is positioned between two adjacent row units 208 with respect to the lateral axis 10 of the corn header 200. Accordingly, a first row unit 208 is positioned on a first lateral side of each pivot joint, and a second row unit 208 is positioned on a second lateral side of the pivot joint, opposite the first lateral side, in which the first and second row units 208 are directly adjacent to one another along the lateral axis 10 of the corn header 200. As used herein, “directly adjacent” refers to two row units that are next to one another without an intervening row unit disposed between the two row units. In addition, in certain embodiments, a crop engagement assembly 202 overlaps at least a portion of each pivot joint with respect to the lateral axis 10 of the corn header 200. In certain embodiments, each crop engagement assembly 202 that at least partially overlaps a respective pivot joint with respect to the lateral axis of the corn header includes a first portion and a second portion. The first portion is coupled to the first row unit, and the second portion is coupled to the second row unit. The first and second portions are configured to move relative to one another in response to lateral flexing of the corn header 200 at the respective pivot joint. Furthermore, the crop engagement assembly 202 is configured to establish an uninterrupted crop engaging exterior during the lateral flexing of the corn header 200. Accordingly, the crop engagement assembly enables the corn header to laterally flex while effectively directing crop material into/through the first row unit. As used herein, “crop engaging exterior” refers to the outer side of the crop engagement assembly (e.g., the divider and/or the hood) configured to engage crop material (e.g., including stalks, ears, leaves, etc.) during operation of the agricultural harvester 100. In addition, as used herein with regard to the crop engaging exterior, “uninterrupted” refers to an arrangement of the crop engaging exterior that blocks crop material from passing through the crop engagement assembly (e.g., to the interior components positioned below the hood). For example, the uninterrupted crop engaging exterior may not have any openings larger than the smallest expected crop material (e.g., including leaves, stalks, ears, etc.).

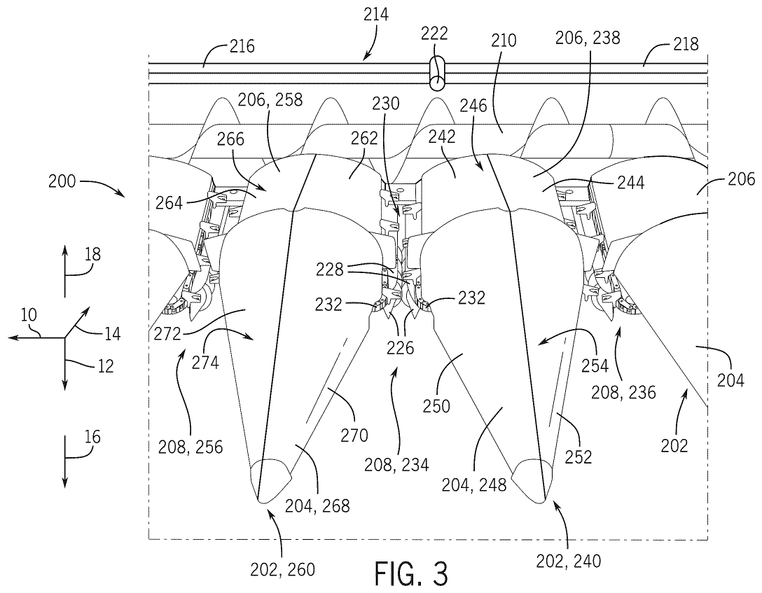

FIG. 3 is a perspective front view of a portion of the corn header 200 of FIG. 2. As previously discussed, the corn header 200 includes multiple dividers 204 that direct the crops into the row units 208. Each row unit 208 is configured to separate the corn ear from the stalk, carry the corn ear toward the respective auger 210, and direct the stalk to the field. As illustrated, each row unit 208 includes a pair of feed rollers 226 configured to grip the stalk and to rotate in opposite directions, thereby driving the stalk rearwardly (e.g., along the rearward direction 18) and toward the field (e.g., vertically downward, below the corn header 200). Each row unit 208 also includes a pair of deck plates 228 positioned over the pair of feed rollers 226. Each deck plate 228 extends along the longitudinal axis 12 of the corn header 200, and the pair of deck plates 228 are separated from one another along the lateral axis 10 of the corn header 200 to define a gap 230. Furthermore, each row unit 208 includes a pair of chains 232 (e.g., with lugs) that are configured to drive or push the corn ear along the pair of deck plates 228 toward the respective auger 210. The pair of deck plates 228 are spaced apart so that the gap 230 is sized to enable the stalk to pass through the gap 230 and to block the corn ear from passing through the gap 230. In some embodiments, the deck plates are adjustable and may be driven (e.g., via an actuator) toward and away from one another along the lateral axis 10 of the corn header 200 to change a size (e.g., width) of the gap. Each hood 206 is positioned rearward of each divider 204 and between adjacent row units 208 to cover various components, such as the actuator that drives the deck plates 228, linkage(s), and so forth. While each row unit includes feed rollers 226, deck plates 228, and chains 232 in the illustrated embodiment, in other embodiments, at least one row unit may include other/additional suitable component(s) configured to facilitate separating the corn ear from the stalk, directing the corn ear to the respective auger, and directing the stalk toward the surface of the agricultural field.

In the illustrated embodiment, the corn header 200 includes a first row unit 234 positioned on a first lateral side of the first pivot joint 222 (e.g., first side of the first pivot joint 222 with respect to the lateral axis 10 of the corn header 200). In addition, the corn header 200 includes a second row unit 236 positioned on a second lateral side of the first pivot joint 222 (e.g., second side of the first pivot joint 222 with respect to the lateral axis 10 of the corn header 200), opposite the first lateral side. As illustrated, the first and second row units are directly adjacent to one another. Furthermore, the corn header 200 includes a first hood 238 of a first crop engagement assembly 240, and the first hood 238 includes a first portion 242 and a second portion 244. The first portion 242 of the first hood 238 is coupled to the first row unit 234, and the second portion 244 of the first hood 238 is coupled to the second row unit 236. The first and second portions of the first hood 238 are configured to move relative to one another in response to lateral flexing of the corn header 200 at the first pivot joint 222 (e.g., in response to rotation of the left wing section 218 of the frame 214 relative to the center section 216 of the frame 214). In addition, the first hood 238 is configured to establish an uninterrupted crop engaging exterior 246 during the lateral flexing of the corn header 200, thereby blocking crop material from passing through the first hood 238. Accordingly, the first hood 238 enables the corn header 200 to laterally flex at the first pivot joint 222 while effectively directing crop material through the first row unit 234.

Furthermore, in the illustrated embodiment, the first crop engagement assembly 240 includes a first divider 248 having a first portion 250 and a second portion 252. The first portion 250 of the first divider 248 is coupled to the first row unit 234, and the second portion 252 of the first divider 248 is coupled to the second row unit 236. The first and second portions of the first divider 248 are configured to move relative to one another in response to lateral flexing of the corn header 200 at the first pivot joint 222 (e.g., in response to rotation of the left wing section 218 of the frame 214 relative to the center section 216 of the frame 214). In addition, the first divider 248 is configured to establish an uninterrupted crop engaging exterior 254 during the lateral flexing of the corn header 200, thereby blocking crop material from passing through the first divider 248. Accordingly, the first divider 248 enables the corn header 200 to laterally flex at the first pivot joint 222 while effectively directing crop material into the first row unit 234.

In the illustrated embodiment, the first hood 238 includes the first portion 242 and the second portion 244. Accordingly, the first crop engagement assembly 240 includes the first and second portions of the first hood 238. However, in other embodiments, the first hood may include a single portion coupled to the first and second row units. Furthermore, in the illustrated embodiment, the first divider 248 includes the first portion 250 and the second portion 252. Accordingly, the first crop engagement assembly 240 includes the first and second portions of the first divider 248. However, in other embodiments, the first divider may include a single portion coupled to the first and second row units.

Furthermore, in the illustrated embodiment, the corn header 200 includes a third row unit 256 positioned on the first lateral side of the first pivot joint 222 (e.g., first side of the first pivot joint 222 with respect to the lateral axis 10 of the corn header 200). Accordingly, the first and third row units are positioned on the same lateral side of the first pivot joint 222. As illustrated, the first and third row units are directly adjacent to one another. Furthermore, the corn header 200 includes a second hood 258 of a second crop engagement assembly 260, and the second hood 258 includes a first portion 262 and a second portion 264. The first portion 262 of the second hood 258 is coupled to the first row unit 234, and the second portion 264 of the second hood 258 is coupled to the third row unit 256. The first and second portions of the second hood 258 are configured to move relative to one another in response to lateral flexing of the corn header 200 at the first pivot joint 222 (e.g., in response to rotation of the left wing section 218 of the frame 214 relative to the center section 216 of the frame 214). In addition, the second hood 258 is configured to establish an uninterrupted crop engaging exterior 266 during the lateral flexing of the corn header 200, thereby blocking crop material from passing through the second hood 258. Accordingly, the second hood 258 enables the corn header 200 to laterally flex at the first pivot joint 222 while effectively directing crop material through the first row unit 234. In addition, because the first portion 242 of the first hood 238 and the first portion 262 of the second hood 258 are coupled to the first row unit 234, the spacing (e.g., distance along the lateral axis 10) between the first portions of the first and second hoods at the base/bottom of the first portions may remain substantially constant as the corn header 200 laterally flexes at the first pivot joint 222, thereby facilitating movement of the crop material through the first row unit 234.

Furthermore, in the illustrated embodiment, the second crop engagement assembly 260 includes a second divider 268 having a first portion 270 and a second portion 272. The first portion 270 of the second divider 268 is coupled to the first row unit 234, and the second portion 272 of the second divider 268 is coupled to the third row unit 256. The first and second portions of the second divider 268 are configured to move relative to one another in response to lateral flexing of the corn header 200 at the first pivot joint 222 (e.g., in response to rotation of the left wing section 218 of the frame 214 relative to the center section 216 of the frame 214). In addition, the second divider 268 is configured to establish an uninterrupted crop engaging exterior 274 during the lateral flexing of the corn header 200, thereby blocking crop material from passing through the second divider 268. Accordingly, the second divider 268 enables the corn header 200 to laterally flex at the first pivot joint 222 while effectively directing crop material into the first row unit 234. In addition, because the first portion 250 of the first divider 248 and the first portion 270 of the second divider 268 are coupled to the first row unit 234, the spacing (e.g., distance along the lateral axis 10) between the first portions of the first and second dividers at the base/bottom of the first portions may remain substantially constant as the corn header 200 laterally flexes at the first pivot joint 222, thereby facilitating movement of the crop material into the first row unit 234.

In the illustrated embodiment, the second hood 258 includes the first portion 262 and the second portion 264. Accordingly, the second crop engagement assembly 260 includes the first and second portions of the second hood 258. However, in other embodiments, the second hood may include a single portion coupled to the first and third row units. Furthermore, in the illustrated embodiment, the second divider 268 includes the first portion 270 and the second portion 272. Accordingly, the second crop engagement assembly 260 includes the first and second portions of the second divider 268. However, in other embodiments, the second divider may include a single portion coupled to the first and third row units.

Furthermore, while the corn header 200 includes a multi-portion crop engagement assembly on each lateral side of the first row unit in the illustrated embodiment, in other embodiments, the corn header may include a multi-portion crop engagement assembly on one lateral side of the first row unit. Furthermore, in certain embodiments, the corn header may include one or more multi-portion crop engagement assemblies positioned adjacent to each row unit that is closest to a respective pivot joint (e.g., along the lateral axis of the corn header). For example, in certain embodiments, the corn header may include a multi-portion crop engagement assembly positioned on each lateral side of the row unit closest to the second pivot joint (e.g., along the lateral axis of the corn header).

Each portion of each multi-portion crop engagement assembly 202 may be coupled to the respective row unit 208 via any suitable type(s) of connection(s). For example, each portion of the hood may be coupled to the respective row unit via a fastener connection, a welded connection, an adhesive connection, other suitable type(s) of connection(s), or a combination thereof. Furthermore, each portion of the divider may be coupled to the respective row unit via a fastener connection, a welded connection, an adhesive connection, other suitable type(s) of connection(s), or a combination thereof. In addition, each portion of each multi-portion crop engagement assembly 202 may be coupled to any non-moving suitable element(s) of the respective row unit 208, such as one of the deck plates 228. Furthermore, in certain embodiments, at least one portion of at least one crop engagement assembly 202 may be indirectly coupled to the respective row unit 208 via intervening structure, such as a mount, a support, the respective frame section, etc. Furthermore, in certain embodiments, each portion of each multi-portion crop engagement assembly 202 may be non-translatably and non-rotatably coupled to the respective row unit. However, in other embodiments, at least one portion of at least one crop engagement assembly may be translatably and/or rotatably coupled to the respective row unit.

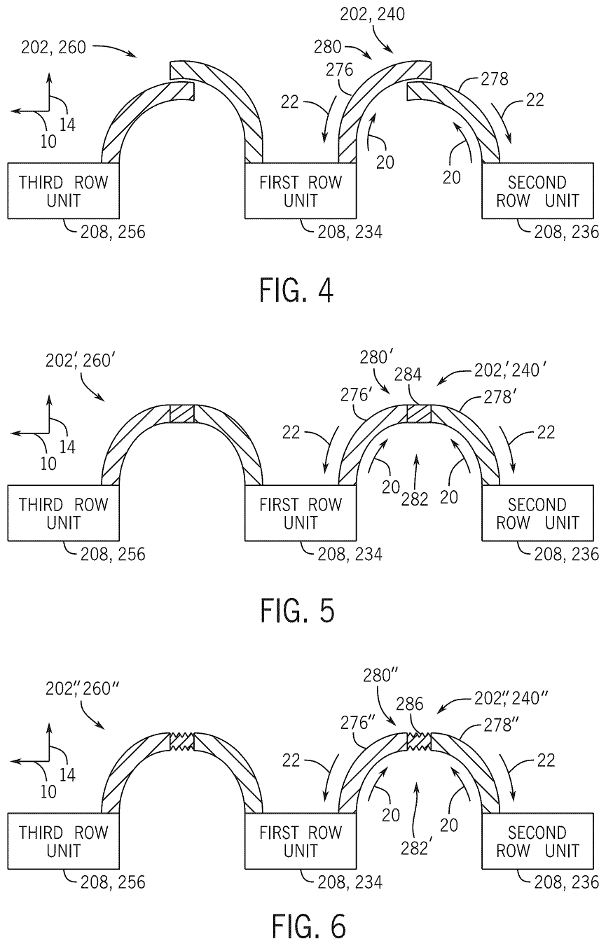

FIG. 4 is a schematic cross-sectional view of an embodiment of crop engagement assemblies 202 that may be employed within the corn header of FIG. 2. As previously discussed, the first crop engagement assembly 240 includes a first portion 276 and a second portion 278. The first portion 276 may correspond to the first portion of the first hood and/or the first portion of the first divider, and the second portion 278 may correspond to the second portion of the first hood and/or the second portion of the first divider, as disclosed above with reference to FIG. 3. The first portion 276 of the first crop engagement assembly 240 is coupled to the first row unit 234, and the second portion 278 of the first crop engagement assembly 240 is coupled to the second row unit 236. In addition, the first and second portions are configured to move relative to one another in response to lateral flexing of the corn header at the pivot joint, and the first crop engagement assembly 240 is configured to establish an uninterrupted crop engaging exterior 280 during the lateral flexing of the corn header. The uninterrupted crop engaging exterior 280 may correspond to the uninterrupted crop engaging exterior of the first hood and/or the uninterrupted crop engaging exterior of the first divider, as disclosed above with reference to FIG. 3.

In the illustrated embodiment, the first and second portions of the first crop engagement assembly 240 overlap one another to establish the uninterrupted crop engaging exterior 280. As illustrated, the uninterrupted crop engaging exterior 280 extends laterally from the first row unit 234 to the second row unit 236. The overlap enables the corn header to laterally flex at the first pivot joint while effectively maintaining the uninterrupted crop engaging exterior 280 (e.g., while the left wing section of the frame is undeflected with respect to the center section of the frame, during the lateral flexing of the corn header at the first pivot joint, and while the left wing section is deflected with respect to the center section). For example, as the first and second row units pivot toward one another in an inward direction 20 in response to deflection of the left wing section of the frame with respect to the center section of the frame in the inward direction 20, the amount of overlap increases. In addition, as the first and second row units pivot away from one another in an outward direction 22 in response to deflection of the left wing section with respect to the center section in the outward direction 22, the amount of overlap decreases. The amount of overlap while the left wing section is undeflected with respect to the center section may be particularly selected to maintain the uninterrupted crop engaging exterior 280 at a maximum expected deflection of the left wing section with respect to the center section in the outward direction 22.

In certain embodiments, the first and second portions may be configured to contact one another through the range of motion of the left wing section relative to the center section to maintain the uninterrupted crop engaging exterior. However, in other embodiments, the first and second portions may be spaced apart from one another (e.g., with respect to the vertical axis of the corn header), thereby establishing a gap between the first and second portions. In such embodiments, the gap may be small enough to block crop material from passing through the first crop engagement assembly 240. Furthermore, in certain embodiments, a bushing may be disposed between the first and second portions (e.g., along the vertical axis of the corn header) to facilitate movement of the first and second portions relative to one another and to block at least a portion of the gap.

Each portion of the first crop engagement assembly 240 is substantially rigid, and each portion of the first crop engagement assembly 240 may be formed from any suitable material(s). For example, in certain embodiments, at least one portion of the first crop engagement assembly may be formed from metal, a polymeric material, a composite material, or a combination thereof. As used herein with regard to the first and second portions, “substantially rigid” refers to the ability of the portion to substantially maintain the initial shape of the portion during operation of the agricultural harvester. Furthermore, while the first crop engagement assembly 240 includes two portions in the illustrated embodiment, in other embodiments, the first crop engagement assembly may include three or more portions. In such embodiments, the first portion may be coupled to the first row unit, the second portion may be coupled to the second row unit, and additional portion(s) may extend between the first and second portions. The additional portion(s) may be supported by the first portion and/or the second portion (e.g., via a sliding assembly, a track assembly, etc.).

In embodiments in which the first portion 276 of the first crop engagement assembly 240 corresponds to the first portion of the first divider, and the second portion 278 of the first crop engagement assembly 240 corresponds to the second portion of the first divider, one portion may be configured to establish the tip of the first divider. For example, the first portion may include the tip, and the second portion may be longitudinally offset from the tip (e.g., an end of the second portion may be positioned behind the tip with respect to the longitudinal axis of the corn header). Furthermore, while the overlapping configuration of the first and second portions is disclosed above with regard to the first crop engagement assembly 240, one or more other crop engagement assemblies of the corn header (e.g., including the second crop engagement assembly 260, etc.) may have the overlapping configuration disclosed above.

FIG. 5 is a schematic cross-sectional view of another embodiment of crop engagement assemblies 202′ that may be employed within the corn header of FIG. 2. As previously discussed, the first crop engagement assembly 240′ includes a first portion 276′ and a second portion 278′. The first portion 276′ may correspond to the first portion of the first hood and/or the first portion of the first divider, and the second portion 278′ may correspond to the second portion of the first hood and/or the second portion of the first divider, as disclosed above with reference to FIG. 3. The first portion 276′ of the first crop engagement assembly 240′ is coupled to the first row unit 234, and the second portion 278′ of the first crop engagement assembly 240′ is coupled to the second row unit 236. In addition, the first and second portions are configured to move relative to one another in response to lateral flexing of the corn header at the pivot joint, and the first crop engagement assembly 240′ is configured to establish an uninterrupted crop engaging exterior 280′ during the lateral flexing of the corn header. The uninterrupted crop engaging exterior 280′ may correspond to the uninterrupted crop engaging exterior of the first hood and/or the uninterrupted crop engaging exterior of the first divider, as disclosed above with reference to FIG. 3.

In the illustrated embodiment, the first crop engagement assembly 240′ includes a stretchable section 282 coupled to the first and second portions of the first crop engagement assembly 240′ to establish the uninterrupted crop engaging exterior 280′. As illustrated, the uninterrupted crop engaging exterior 280′ extends laterally from the first row unit 234 to the second row unit 236. Furthermore, in the illustrated embodiment, the stretchable section 282 includes a stretchable fabric 284. The stretchable fabric 284 is configured to expand and contract as the corn header flexes at the first pivot joint while effectively maintaining the uninterrupted crop engaging exterior 280′ (e.g., while the left wing section of the frame is undeflected with respect to the center section of the frame, during the lateral flexing of the corn header at the first pivot joint, and while the left wing section is deflected with respect to the center section). For example, as the first and second row units pivot toward one another in the inward direction 20 in response to deflection of the left wing section of the frame with respect to the center section of the frame in the inward direction 20, the stretchable fabric 284 contracts. In addition, as the first and second row units pivot away from one another in the outward direction 22 in response to deflection of the left wing section with respect to the center section in the outward direction 22, the stretchable fabric 284 expands. The resilience and the width (e.g., extent along the lateral axis 10 of the corn header) of the stretchable fabric 284 may be particularly selected based on a maximum expected deflection of the left wing section with respect to the center section in the outward direction 22.

Each portion of the first crop engagement assembly 240′ is substantially rigid, and each portion of the first crop engagement assembly 240′ may be formed from any suitable material(s). For example, in certain embodiments, at least one portion of the first crop engagement assembly may be formed from metal, a polymeric material, a composite material, or a combination thereof. Furthermore, the stretchable fabric 284 may be formed from any suitable material(s), such as elastic fibers extending along the lateral axis 10 of the corn header. In addition, the stretchable fabric 284 may include any suitable number of layers (e.g., 1, 2, 3, 4, 5, 6, 7, 8, or more). While the first crop engagement assembly 240′ includes two portions and one stretchable section 282 in the illustrated embodiment, in other embodiments, the first crop engagement assembly may include three or more portions. In such embodiments, one stretchable section may be positioned between each adjacent pair of portions.

In embodiments in which the first portion 276′ of the first crop engagement assembly 240′ corresponds to the first portion of the first divider, and the second portion 278′ of the first crop engagement assembly 240′ corresponds to the second portion of the first divider, one portion may be configured to establish the tip of the first divider. For example, the first portion may include the tip, and the second portion may be longitudinally offset from the tip (e.g., an end of the second portion may be positioned behind the tip with respect to the longitudinal axis of the corn header). Furthermore, while the first crop engagement assembly 240′ includes the stretchable section 282 having the stretchable fabric 284, one or more other crop engagement assemblies of the corn header (e.g., including the second crop engagement assembly 260′, etc.) may include a stretchable section having a stretchable fabric, as disclosed above.

FIG. 6 is a schematic cross-sectional view of a further embodiment of crop engagement assemblies 202″ that may be employed within the corn header of FIG. 2. As previously discussed, the first crop engagement assembly 240″ includes a first portion 276″ and a second portion 278″. The first portion 276″ may correspond to the first portion of the first hood and/or the first portion of the first divider, and the second portion 278″ may correspond to the second portion of the first hood and/or the second portion of the first divider, as disclosed above with reference to FIG. 3. The first portion 276″ of the first crop engagement assembly 240″ is coupled to the first row unit 234, and the second portion 278″ of the first crop engagement assembly 240″ is coupled to the second row unit 236. In addition, the first and second portions are configured to move relative to one another in response to lateral flexing of the corn header at the pivot joint, and the first crop engagement assembly 240″ is configured to establish an uninterrupted crop engaging exterior 280″ during the lateral flexing of the corn header. The uninterrupted crop engaging exterior 280″ may correspond to the uninterrupted crop engaging exterior of the first hood and/or the uninterrupted crop engaging exterior of the first divider, as disclosed above with reference to FIG. 3.

In the illustrated embodiment, the first crop engagement assembly 240″ includes a stretchable section 282′ coupled to the first and second portions of the first crop engagement assembly 240″ to establish the uninterrupted crop engaging exterior 280″. As illustrated, the uninterrupted crop engaging exterior 280″ extends laterally from the first row unit 234 to the second row unit 236. Furthermore, in the illustrated embodiment, the stretchable section 282′ includes a folding structure 286 (e.g., accordion structure). The folding structure 286 is configured to expand and contract as the corn header flexes at the first pivot joint while effectively maintaining the uninterrupted crop engaging exterior 280″ (e.g., while the left wing section of the frame is undeflected with respect to the center section of the frame, during the lateral flexing of the corn header at the first pivot joint, and while the left wing section is deflected with respect to the center section). For example, as the first and second row units pivot toward one another in the inward direction 20 in response to deflection of the left wing section of the frame with respect to the center section of the frame in the inward direction 20, the folding structure 286 contracts. In addition, as the first and second row units pivot away from one another in the outward direction 22 in response to deflection of the left wing section with respect to the center section in the outward direction 22, the folding structure 286 expands. The resilience and the width (e.g., extent along the lateral axis 10 of the corn header) of the folding structure 286 may be particularly selected based on a maximum expected deflection of the left wing section with respect to the center section in the outward direction 22.

Each portion of the first crop engagement assembly 240″ is substantially rigid, and each portion of the first crop engagement assembly 240″ may be formed from any suitable material(s). For example, in certain embodiments, at least one portion of the first crop engagement assembly may be formed from metal, a polymeric material, a composite material, or a combination thereof. Furthermore, the folding structure 286 may be formed from any suitable material(s), such as a sheet of material having multiple folds, multiple rigid sections connected by pivot joints, etc. In addition, the folding structure 286 may include any suitable number of layers (e.g., 1, 2, 3, 4, 5, 6, 7, 8, or more). While the first crop engagement assembly 240″ includes two portions and one stretchable section 282′ in the illustrated embodiment, in other embodiments, the first crop engagement assembly may include three or more portions. In such embodiments, one stretchable section may be positioned between each adjacent pair of portions.

In embodiments in which the first portion 276″ of the first crop engagement assembly 240″ corresponds to the first portion of the first divider, and the second portion 278″ of the first crop engagement assembly 240″ corresponds to the second portion of the first divider, one portion may be configured to establish the tip of the first divider. For example, the first portion may include the tip, and the second portion may be longitudinally offset from the tip (e.g., an end of the second portion may be positioned behind the tip with respect to the longitudinal axis of the corn header). Furthermore, while the first crop engagement assembly 240″ includes the stretchable section 282′ having the folding structure 286, one or more other crop engagement assemblies of the corn header (e.g., including the second crop engagement assembly 260″, etc.) may include a stretchable section having a folding structure, as disclosed above. In addition, while a stretchable section having a stretchable fabric and a stretchable section having a folding structure are disclosed above, in certain embodiments, the stretchable section may include another suitable type of structure configured to facilitate lateral flexing of the corn header while establishing the uninterrupted crop engaging exterior during the lateral flexing of the corn header. Furthermore, in certain embodiments, a corn header may include a crop engagement assembly having the overlapping configuration, a crop engagement assembly having the stretchable section with the stretchable fabric, a crop engagement assembly having the stretchable section with the folding structure, or a combination thereof.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A flexible header for an agricultural harvester, comprising:
a crop engagement assembly comprising a first portion and a second portion, wherein the first portion is configured to couple to a first row unit of the flexible header, the second portion is configured to couple to a second row unit of the flexible header, which is directly adjacent to the first row unit, the first and second portions are configured to move relative to one another in response to lateral flexing of the flexible header at a pivot joint positioned laterally between the first and second row units, and the crop engagement assembly is configured to establish an uninterrupted crop engaging exterior during the lateral flexing of the flexible header.

2. The flexible header of claim 1, wherein the first and second portions of the crop engagement assembly overlap one another to establish the uninterrupted crop engaging exterior.

3. The flexible header of claim 1, wherein the crop engagement assembly comprises a stretchable section coupled to the first and second portions to establish the uninterrupted crop engaging exterior.

4. The flexible header of claim 3, wherein the stretchable section comprises a stretchable fabric.

5. The flexible header of claim 3, wherein the stretchable section comprises a folding structure.

6. The flexible header of claim 1, wherein the crop engagement assembly comprises a hood, a divider, or a combination thereof.

7. The flexible header of claim 1, comprising a second crop engagement assembly comprising a first portion and a second portion, wherein the first portion of the second crop engagement assembly is configured to couple to the first row unit of the flexible header, the second portion of the second crop engagement assembly is configured to couple to a third row unit of the flexible header, which is directly adjacent to the first row unit, the first and second portions of the second crop engagement assembly are configured to move relative to one another in response to the lateral flexing of the flexible header at the pivot joint, and the second crop engagement assembly is configured to establish an uninterrupted crop engaging exterior during the lateral flexing of the flexible header.

8. The flexible header of claim 7, wherein the second crop engagement assembly comprises a hood, a divider, or a combination thereof.

9. A flexible header for an agricultural harvester, comprising:
a hood comprising a first portion and a second portion, wherein the first portion of the hood is configured to couple to a first row unit of the flexible header, the second portion of the hood is configured to couple to a second row unit of the flexible header, which is directly adjacent to the first row unit, the first and second portions of the hood are configured to move relative to one another in response to lateral flexing of the flexible header at a pivot joint positioned laterally between the first and second row units, and the hood is configured to establish an uninterrupted crop engaging exterior during the lateral flexing of the flexible header; and
a divider comprising a first portion and a second portion, wherein the first portion of the divider is configured to couple to the first row unit of the flexible header, the second portion of the divider is configured to couple to the second row unit of the flexible header, the first and second portions of the divider are configured to move relative to one another in response to the lateral flexing of the flexible header at the pivot joint, and the divider is configured to establish an uninterrupted crop engaging exterior during the lateral flexing of the flexible header.

10. The flexible header of claim 9, wherein the first and second portions of the hood overlap one another to establish the uninterrupted crop engaging exterior of the hood, the first and second portions of the divider overlap one another to establish the uninterrupted crop engaging exterior of the divider, or a combination thereof.

11. The flexible header of claim 9, wherein the hood comprises a stretchable section coupled to the first and second portions of the hood to establish the uninterrupted crop engaging exterior of the hood, the divider comprises a stretchable section coupled to the first and second portions of the divider to establish the uninterrupted crop engaging exterior of the divider, or a combination thereof.

12. The flexible header of claim 11, wherein the stretchable section of the hood comprises a stretchable fabric, the stretchable section of the divider comprises a stretchable fabric, or a combination thereof.

13. The flexible header of claim 11, wherein the stretchable section of the hood comprises a folding structure, the stretchable section of the divider comprises a folding structure, or a combination thereof.

14. The flexible header of claim 9, comprising:
a second hood comprising a first portion and a second portion, wherein the first portion of the second hood is configured to couple to the first row unit of the flexible header, the second portion of the second hood is configured to couple to a third row unit of the flexible header, which is directly adjacent to the first row unit, the first and second portions of the second hood are configured to move relative to one another in response to the lateral flexing of the flexible header at the pivot joint, and the second hood is configured to establish an uninterrupted crop engaging exterior during the lateral flexing of the flexible header; and
a second divider comprising a first portion and a second portion, wherein the first portion of the second divider is configured to couple to the first row unit of the flexible header, the second portion of the second divider is configured to couple to the third row unit of the flexible header, the first and second portions of the second divider are configured to move relative to one another in response to the lateral flexing of the flexible header at the pivot joint, and the second divider is configured to establish an uninterrupted crop engaging exterior during the lateral flexing of the flexible header.

15. A flexible header for an agricultural harvester, comprising:
a frame having a first section and a second section;
a pivot joint pivotally coupling the first and second sections to one another;
a first row unit positioned on a first lateral side of the pivot joint;
a second row unit positioned on a second lateral side of the pivot joint, opposite the first lateral side, wherein the first and second row units are directly adjacent to one another; and
a crop engagement assembly comprising a first portion and a second portion, wherein the first portion is coupled to the first row unit, the second portion is coupled to the second row unit, the first and second portions are configured to move relative to one another in response to lateral flexing of the flexible header at the pivot joint, and the crop engagement assembly is configured to establish an uninterrupted crop engaging exterior during the lateral flexing of the flexible header.

16. The flexible header of claim 15, wherein the first and second portions of the crop engagement assembly overlap one another to establish the uninterrupted crop engaging exterior.

17. The flexible header of claim 15, wherein the crop engagement assembly comprises a stretchable section coupled to the first and second portions to establish the uninterrupted crop engaging exterior.

18. The flexible header of claim 17, wherein the stretchable section comprises a stretchable fabric.

19. The flexible header of claim 17, wherein the stretchable section comprises a folding structure.

20. The flexible header of claim 15, wherein the crop engagement assembly comprises a hood, a divider, or a combination thereof.
